(19) United States
(12) Patent Application Publication
(10) Pub. No.: US 2010/0221540 A1
(43) Pub. Date: Sep. 2, 2010

(54) Process for Producing a Porous Glass and Glass Powder and Glass Material for Carrying Out the Process

(75) Inventor: Monika Hermann, Sonneberg (DE)

Correspondence Address: Gerald T. Bodner;BODNER & O''ROURKE, LLP, 425 BROADHOLLOW ROAD, SUITE 120, MELVILLE, NY, 11747, US

(73) Assignee: VitraBio GmbH, Steinach (DE)

(21) Appl. No.: 12/224,067

(22) PCT Filed: Feb. 24, 2006
(86) PCT No.: PCT/EP2006/001739

§ 371 Date: May 20, 2010

(51) Int. Cl. C03C 11/00; C03B 19/10

(52) U.S. Cl. 428/402; 65/21.4; 501/39

(57) ABSTRACT

The invention relates to a process for producing a porous glass and glass powder using a partial Vycor process on an alkali metal borosilicate glass material. The process is characterized in that an addition of metal oxides and/or rare earth metal oxides in variable proportions of from 0.05 to 15 percent by mass is carried out on the alkali metal borosilicate glass material during the course of the Vycor process, with a doping incorporation of the metal oxides and/or the rare earth metal oxides into the resulting SiO₂ matrix with an increase in the optical index of refraction of the porous glass being brought about during the Vycor process, and an opposed jet milling process is employed in combination with a ceramic sifter wheel in a subsequent dry milling process, with classification of the porous glass particles produced which have a size range of less than 15 μm being carried out. The porous glass material is characterized by a ternary SiO₂—B₂O₃—Na₂O base mixture having an adjustable optical index fraction in a material composition having the following variable proportions of metal and lanthanide oxides: 0.001-0.1% by mass of Fe₂O₃, 0.01-0.2% by mass of MgO, 0.05-15% by mass of ZrO₂, 0.5-15% by mass of La₂O₃, 0.5-15% by mass of WO₃, 0.5-15% by mass of TiO₂.

The invention relates to a method for manufacturing a porous glass and glass powder in accordance with the preamble of claim 1, a porous glass material in accordance with the preamble of claim 5, and the use of the porous glass material in accordance with the preamble of claim 7.

The term ‘porous glasses’ covers glass objects or glass materials, respectively, with a sponge-type structure. This structure comprises continuous pores which open to the outside. Porous glasses comprise a wide technological application spectrum and are used, for example, in the form of bars, plates, tubes, grit, balls, or fibres in chromatography for the separation and enrichment of biological or chemical substances, respectively, for the enzyme immobilisation, as a carrier material for catalysts, chelating agents and indicators, in the immunosorbent technique, in the separation of micro organisms, in particular viruses, but also for the manufacture of implants, in particular, dental implants.

A detailed presentation of porous glasses and their manufacturing method is given e.g. in G. Greiner-Bär and M. Schäfer “Poröse Gläser—neue Glasprodukte”, Technische Gemeinschaft 6/1989, or in “Poröse Mikroglaskugeln—ein neuer Glaswerkstoff”, Silikattechnik 40 (1989), No. 6.

For the manufacture of porous glass structures a partial Vycor process is employed. In such a method, an alkali boron silicate glass with a ternary mixture based on SiO₂—B₂O₃—Na₂O with a number of other additives in the range of the boric acid anomaly is molten, brought into a shape which lends itself to a technological handability, and subsequently subjected to a heat treatment at temperatures ranging from 500 to 750° C. Thereby, a phase separation occurs into an SiO₂ phase with low solubility and a borate-containing mixed phase with high solubility, which form a continuous penetration structure. The borate-containing mixed phase with high solubility is then extracted from the glass body by means of suitable extraction agents, such as water, bases, or acids. A body remains which consists of an essentially pure SiO₂ skeleton.

For an exemplary composition of the base glass material, reference is made to the literature, e.g. Greiner-Bär, Schäfer: Silikattechnik 40 (1989), No. 6, pp. 184 to 187, or to publication DE-OS 14 96 573. According to F. Janowski, W. Heyer “Poröse Glaser”, VEB Deutscher Verlag für Grundstoffundustrie, Leipzig, the following physical properties of porous glasses are achieved: Pore diameters between 0.26 and 1000 nm with a specific surface of 40 to 300 m²/g and a pore volume of 0.1 to 0.7 cm³/g and an application range with a pH value of up to 8.

German Patent Specification DE 41 02 635 C2 proposes a base glass for a dense monodisperse pore distribution with the following chemical composition: 60 to 65 percent by mass SiO₂; 27 to 28 percent by mass B₂O₃; 5 to 6.5 percent by mass Na₂O; 0.1 to 1 percent by mass K₂O₅; 0.2 to 0.5 percent by mass CaO; 0.4 to 0.5 percent by mass Al₂O₃; 0.3 to 0.5 percent by mass P₂O₅; 0.4 to 1.8 percent by mass Fe₂O₃; 0.1 to 0.5 percent by mass MgO; 0.1 to 1.0 percent by mass TiO₂; 0.2 to 1.0 percent by mass ZrO₂. The metal oxides Fe₂O₃, MgO, TiO₂, and ZrO₂ are added in only small quantities according to the state of the art for influencing the phase separation process, for influencing the interfacial energy, or the interfacial tension, respectively, between the two phases, for stabilising the glass matrix, and for an improved resistance of the porous glass against bases. In the following extraction process, the oxidic components together with the borate-containing phase are essentially washed out and do not remain in the SiO₂ matrix.

Such porous glasses are used i.a. in the form of glass grit or glass powder. For the production of glass grit or glass powder from such a porous glass material, the German Patent Specification DE 196 33 257 C1 proposes a method wherein the base glass is crushed prior to the described extraction, then the extraction process carried out, and the then porous glass particles are ground by a counter jet method in a jet mill to a particle size of less than 20 μm. According to the teaching of the publication, classifying by screening of the obtained porous glass particles is done by means of an air separator which is capable of sorting fractions of particles with a size of less than 50 μm. The ground product is supplied through a rotating wheel with a number of openings with a defined diameter, with the passing of precisely determined particle sizes being possible as a function of the speed of the classifying wheel.

Such powders of porous glass particles lends themselves in particular for use in a composite material with a synthetic or similar material in the field of dental restoration and in the implant technique, with the particle and pore size advantageously influencing the elasticity of the composite and matching it to the mechanical and optical properties of the surrounding tissue, e.g. the enamel.

The unexamined German application DE 198 17 869 A1 proposes a coating of the porous glass, in particular, of the base glass frit, with an oxidic component or the fusion of such a component in order to improve the X-ray contrast, i.e. the X-ray absorption of such composites.

The coating process therein is mainly carried out in a wet-chemical method, whereby the solutions of the oxidic components are introduced into the glass pores where they chemically combine with the reactive silanol centres at the pore inner walls, with the X-ray opacity of the glass material being able to be increased significantly. Such methods, however, require an expensive and time-consuming additional post treatment of the porous glass.

Such porous glass materials and powder-type glass materials known from the state of the art, however, suffer from the problem in that the particle sizes of less than 20 μm, which have been achieved so far, are too large for an application in the field of dentistry. For a fairly satisfactory mechanical matching of such composites with the enamel, particle sizes as small as possible which hitherto are not feasible would be desirable. Moreover, such composites are aesthetically disadvantageous so that their employment in the front teeth region is still limited. This is due to the essentially defined optical properties of the composites, which manifest themselves in particular in a too low refractive index of the glass particles, which for the time being cannot be influenced. Consequently, such composites which actually would be very advantageous under mechanical aspects can either not be employed with certain enamel hues or only at the cost of cosmetic or aesthetic, respectively, drawbacks.

In addition, increasing or selectively influencing the refractive index of porous glasses or porous glass particles, respectively, in connection with reducing the particle size is desirable for a number of other applications. This combination of properties may be of advantage e.g. in the analytic entry of individual particles in the preparation of substance libraries or in the development of composites for the application in optical or opto-electronic devices with non-linear characteristics.

It is the object to specify a manufacturing method for a porous glass and a glass powder, which is capable of selectively effecting a significant increase of the optical refractive index in the SiO₂ matrix and in conjunction therewith of significantly reducing the size of the porous glass particles. In addition, there is the object to specify a glass material which shows such an increase in the refractive index. Finally, there is the object to provide an application for such a material.

The object is solved by means of a method for the manufacture of a porous glass and glass powder with the characteristics of claim 1, a glass material with the characteristics of claim 5, and an application of the glass material with the characteristics of claim 7, with the respective dependent claims including suitable embodiments of the manufacturing method, the material, or the application, respectively.

The method for the manufacture of the porous glass is based in the partial Vycor process with an alkali boron silicate glass material, which is followed by a dry grinding process for producing the porous glass particles. According to the invention, the method is characterised in that in the course of the Vycor process metal oxides and/or rare earth (lanthanum oxide) oxides in variable proportions of 0.05 to 15 percent by mass are added to the alkali boron silicate glass material, with a doping insertion of the metal oxides and/or the rare earth oxides into the SiO₂ matrix being generated which is accompanied by an increase of the optical refractive index of the porous glass being effected during the Vycor process. The method is further characterised in that in the subsequent dry grinding process a counter jet grinding method with a ceramic separator wheel is employed, with a classification of the produced porous glass particles of a size ranging below 15 μm being carried out.

Accordingly, the inventive method combines a modified partial Vycor process which is configured to doping the SiO₂ skeleton structure with an improved classifying technique. Doting of the SiO₂ matrix is carried out in a technological step with the formation of the porous structure itself, whereby a later coating or post treatment of the material may be omitted.

Contrary to the prevailing opinions which are dominating in the state of the art, it has been found that the metal or rare earth oxides, respectively, which are added to the glass material, are embedded at least partially in a permanent manner not only in the pore surfaces of the glass but directly in the SiO₂ matrix, where they are able to systematically effect an increase of the refractive index to a value of up to 1.50. For glass materials of this type, this has hitherto been unusual. The required optical properties are achieved in this manner, which are desired for the above mentioned composite materials. The significantly finer glass particles facilitate the mixing behaviour of the glass material into such a composite and allow for a greater quantity of a porous filler substance which may be mixed into the composite. The composite thus comprises fundamentally improved mechanical properties, such as an increased abrasion resistance, a better polishing behaviour, an increased strength, and reduced shrinkage.

The ceramic separator wheel enables a simpler construction of the classifying arrangement, significantly higher speeds, and thereby effects the classification of the glass particles to values of less than 15 μm. Moreover, the ceramic separator wheel has a significantly higher resistance against wear and abrasion. This ensures a significantly improved product purity in conjunction with a longer service life of the classifying wheel.

In a preferred embodiment of the method, zirconium(IV) oxide, tungsten(VI) oxide, and/or titanium(IV) oxide as metal oxides are added either individually or in combination. It was found that these metal oxides insert themselves are particularly well into the SiO₂ structure and contribute to the increase in the refractive index in an essentially extent.

As the rare earth oxide lanthumum(III) oxide is preferably added. Experiments have shown that approx. 70 percent of the added amount of this oxide is bound in the SiO₂.

The metal oxide and/or the rare earth oxide are suitably added during melting of the alkali boron silicate glass in the range of the boric acid anomaly by means of an agitation operation.

A glass material for carrying out the mentioned manufacturing method is characterised by a ternary SiO₂—B₂O₃—Na₂O base mixture in a material composition with the following variable mass proportions:
50 to 56 percent by mass SiO₂;
28 to 30 percent by mass B₂^{O}₃;
5.5 to 6.5 percent by mass Na₂O;
0.2 to 0.4 percent by mass K₂O;
0.2 to 0.5 percent by mass CaO;
0.7 to 1.0 percent by mass Al₂O₃;
0.2 to 0.4 percent by mass P₂O₅;
0.5 to 1.0 percent by mass F;
0.001 to 0.1 percent by mass Fe₂O₃;
0.01 to 0.2 percent by mass MgO;
0.05 to 15 percent by mass ZrO₂;
0.5 to 15 percent by mass La₂O₃;
0.5 to 15 percent by mass WO₃;
0.5 to 15 percent by mass TiO₂.

The glass material is further characterised by a pulverised embodiment with a particle size of 15 μm and less.

The use of the porous glass material in the form of a pulverised glass material and of a composite which contains a synthetic material corresponding to the refractive index of the glass material as a dental filler material for the front and side teeth region is provided. Due to the refractive indices which are matched with one another, the composite has a trans-lucent appearance and may be applied in the teeth area in an aesthetically advantageous manner, with the mechanical properties of such composites being fully utilised.

In addition, an application of the porous glass material in the form of a composite which contains the pulverised glass material and a synthetic material corresponding to the refractive index of the glass material as a mouldable embedding material for liquid crystalline materials in optical displays is provided.

The invention will be described in more detail in the following with reference to several embodiments.

An exemplary glass material for carrying out the method consists of a ternary base mixture of 52 percent by mass SiO₂; 29 percent by mass B₂O₃; and 6.1 percent by mass Na₂O. A small addition of up to 0.3 percent by mass K₂O improves the acid resistance of the glass material. CaO is of essential importance for the phase separation process; a content of 0.3 to 0.4 percent by mass has proven to be advantageous. Al₂O₃ increases the chemical resistance of the glass and reduces its crystallisation tendency. A slightly higher value of 0.8 to 0.9 percent by mass was found to be a particularly advantageous value for the content of the Al₂O₃, in particular, with respect to the added metal oxides. The content of P₂O₅ should not exceed a value of 0.4 percent by mass, which is slightly lower than the value for glass compositions known in state of the art. A content of 0.3 percent by mass P₂O₅ has proven particularly suitable for a stable pore size and a specific surface as large as possible of the porous glass.

The content of Fe₂O₃ is reduced to approx. one third of the conventional value of glass compositions which are known in the state of the art. This takes the effects of the metal oxides which are added later to the mixture into consideration. The content of Fe₂O₃ should not exceed 0.1 percent by mass. A content of 0.05 to 0.07 percent by mass is advantageous.

The alkali boron silicate glass of the above composition is molten at the usual melting temperatures. Then, zirconium(IV) oxide, ZrO₂, lanthanum(III) oxide, La₂O₃, tungsten(VI) oxide, WO₃, and titanium(IV) oxide, TiO₂, are added either individually or in combination. The addition of the mentioned substances may either be in the form of a previously prepared material mixture or successively, with the oxides being added successively to the melt by agitation. This is followed by heat treatment which results in the phase separation.

The total quantity of the added ZrO₂, La₂O₃, WO₃, and TiO₂ should not exceed 15 percent by mass. The respective proportions of the additives may, however, be varied essentially freely within these upper limits. In particular, it is possible to provide the same proportion for each oxide within the mass range from 3.6 to 3.8 percent by mass.

For the manufacture of glass powder with a particle size of less than 15 μm, the counter jet method with a ceramic separator wheel is employed. In the counter jet method, the glass particles which have been crushed in advance in a first step are blown against each other by an air stream so that they themselves break each other up. The ceramic separator wheel comprises a number of openings like conventional models and has a certain thickness. The ceramic base material of the separator wheel and the associated smaller moment of inertia enable higher speeds to be achieved. The ceramic material of the wheel has a significantly higher resistance against abrasion and wear. This ensures a reliable classification of the porous glass particles down to a size of less than 15 μm. The separator wheel may comprise slit-type or hole-type classifying openings. Hole-type openings result in a particularly good classification of uniform essentially spherical glass particles with a high degree of fineness. Depending on the actual configuration and the thickness of the separator wheel as well as on the velocity of the particles flowing about the classifying wheel, the separator wheel is operated at a speed of up to 12,000 min⁻¹.

When the pulverised glass material is used in a composite for a dental implant, the porous glass powder is embedded in an organic polymer matrix or mixed into it. The polymer material is, in particular, hardenable by UV radiation. Due to the identical refractive index of the glass particles and the polymer composite component, the composite exhibits high translucency with minimised turbidity.

When the glass material or the composite of glass powder and synthetic material, respectively, is to be used as an embedding material in the display technology, the initially soft and mouldable composite is inserted into a matrix and deformed under pressure in an imprinting method. In the course of the imprinting method the electrodes or contacts, respectively, of the display may be added. The composite is then UV hardened and forms a solid substrate block which is then filled with the liquid crystalline material. A major advantage of such substrate blocks with a higher refractive index is the significantly reduced light absorption at the interface between the liquid crystal and the substrate. Nematic liquid crystals have a refractive index in the range of 1.5. The refractive index of the substrate block form from the described material lies in the same region and may be designed variably by a different doping of the porous glass material.

1. A method for the manufacture of a porous glass and glass powder by means of a partial Vycor process with an alkali boron silicate glass material, wherein a phase separation into an SiO₂ phase with low solubility and a borate-containing mixed phase with high solubility in a penetration structure is carried out, followed by an extraction of the mixed phase under the formation of a porous SiO₂ matrix and a subsequent dry-grinding process for the generation of porous glass particles,
characterised in that
in the course of the Vycor process, metal oxides and/or rare earth (lanthanum oxide) oxides in variable proportions of 0.05 to 15 percent by mass each are added to the alkali boron silicate glass material, with a doping insertion of the metal oxides and/or the rare earth oxides into the SiO₂ matrix being generated whereby an increase of the optical refractive index of the porous glass is effected during the Vycor process,
in the subsequent dry grinding process a counter jet grinding method with a ceramic separator wheel is employed, with a classification of the produced porous glass particles of a size range of less than 15 μm being carried out.

2. The manufacturing methods according to claim 1,
characterised in that
zirconium(IV) oxide, tungsten(VI) oxide, and/or titanium(IV) oxide are added either individually or in combination as the metal oxides.

3. The manufacturing methods according to claim 1,
characterised in that
lanthumum(III) oxide is added as the rare earth oxide.

4. The manufacturing methods according to claim 1,
characterised in that
the metal oxide and/or the rare earth oxide are added during melting of the alkali boron silicate glass in the range of the boric acid anomaly by means of an agitation operation.

5. A porous glass material,
characterised by
a ternary SiO₂—B₂O₃—Na₂O base mixture with an adjustable optical refractive index in a material composition with the following variable mass proportions:
50 to 56 percent by mass SiO₂;
28 to 30 percent by mass B₂O₃;
5.5 to 6.5 percent by mass Na₂O;
0.2 to 0.4 percent by mass K₂O;
0.2 to 0.5 percent by mass CaO;
0.7 to 1.0 percent by mass Al₂O₃;
0.2 to 0.4 percent by mass P₂O₅;
0.5 to 1.0 percent by mass F;
0.001 to 0.1 percent by mass Fe₂O₃;
0.01 to 0.2 percent by mass MgO;
0.05 to 15 percent by mass ZrO₂;
0.5 to 15 percent by mass La₂O₃;
0.5 to 15 percent by mass WO₃;
0.5 to 15 percent by mass TiO₂.

6. The porous glass material according to claim 5,
characterised by
a pulverised embodiment with a particle size of 15 μm and less.

7. An application of a porous glass material according to claim 1,
characterised by
formulations of a composite which contains the pulverised glass material and one or several synthetic materials corresponding to the refractive index of the glass material for use as a dental filler material.

8. The application of a porous glass material according to claim 1,
characterised by
a composite which contains the pulverised glass material and a synthetic material corresponding to the refractive index of the glass material as a mouldable embedding material for liquid crystalline materials in optical displays.

9. An application of a porous glass material according to claim 2,
characterised by
formulations of a composite which contains the pulverised glass material and one or several synthetic materials corresponding to the refractive index of the glass material for use as a dental filler material.

10. An application of a porous glass material according to claim 3,
characterised by
formulations of a composite which contains the pulverised glass material and one or several synthetic materials corresponding to the refractive index of the glass material for use as a dental filler material.

11. An application of a porous glass material according to claim 4,
characterised by
formulations of a composite which contains the pulverised glass material and one or several synthetic materials corresponding to the refractive index of the glass material for use as a dental filler material.

12. An application of a porous glass material according to claim 5,
characterised by
formulations of a composite which contains the pulverised glass material and one or several synthetic materials corresponding to the refractive index of the glass material for use as a dental filler material.

13. An application of a porous glass material according to claim 6,
characterised by
formulations of a composite which contains the pulverised glass material and one or several synthetic materials corresponding to the refractive index of the glass material for use as a dental filler material.

14. The application of a porous glass material according to claim 2,
characterised by
a composite which contains the pulverised glass material and a synthetic material corresponding to the refractive index of the glass material as a mouldable embedding material for liquid crystalline materials in optical displays.

15. The application of a porous glass material according to claim 3,
characterised by
a composite which contains the pulverised glass material and a synthetic material corresponding to the refractive index of the glass material as a mouldable embedding material for liquid crystalline materials in optical displays.

16. The application of a porous glass material according to claim 4,
characterised by
a composite which contains the pulverised glass material and a synthetic material corresponding to the refractive index of the glass material as a mouldable embedding material for liquid crystalline materials in optical displays.

17. The application of a porous glass material according to claim 5,
characterised by
a composite which contains the pulverised glass material and a synthetic material corresponding to the refractive index of the glass material as a mouldable embedding material for liquid crystalline materials in optical displays.

18. The application of a porous glass material according to claim 6,
characterised by
a composite which contains the pulverised glass material and a synthetic material corresponding to the refractive index of the glass material as a mouldable embedding material for liquid crystalline materials in optical displays.

19. The application of a porous glass material according to claim 7,
characterised by
a composite which contains the pulverised glass material and a synthetic material corresponding to the refractive index of the glass material as a mouldable embedding material for liquid crystalline materials in optical displays.
